(19) United States
(12) Patent Application Publication
(10) Pub. No.: US 2018/0047976 A1
(43) Pub. Date: Feb. 15, 2018

(54) NONAQUEOUS ELECTROLYTE SECONDARY BATTERY

(71) Applicant: Murata Manufacturing Co, Ltd., Nagaokakyo-shi (JP)

(72) Inventor: TAKESHI HAYASHI, Nagaokakyo-shi (JP)

(21) Appl. No.: 15/794,210

(22) Filed: Oct. 26, 2017

Related U.S. Application Data
(63) Continuation of application No. PCT/JP2016/064228, filed on May 13, 2016.

(30) Foreign Application Priority Data
May 14, 2015 (JP) 2015-099248

(51) Int. Cl. H01M 4/133; H01M 4/58; H01M 4/52; H01M 4/62; H01M 10/0525

(52) U.S. Cl. CPC H01M 4/133; H01M 4/623; H01M 10/0525; H01M 4/523; H01M 4/5805; H01M 4/136

(57) ABSTRACT

A nonaqueous electrolyte secondary battery including a positive electrode, a negative electrode, and a nonaqueous electrolyte. The positive electrode has a positive electrode active material containing layer on a positive electrode current collector. The positive electrode active material containing layer includes a positive electrode active material containing lithium iron phosphate coated with amorphous carbon, and a conductive agent. The negative electrode has a negative electrode active material containing layer on a negative electrode current collector. When a coated, state of the lithium iron phosphate with the amorphous carbon is quantitatively expressed by Raman spectroscopy, an intensity area ratio A (C/L) of a diffraction line L that appears at 935 cm⁻¹ to 565 cm⁻¹ in wave number in a Raman spectrum of lithium iron phosphate to a diffraction line C that appears at 965 cm⁻¹ to 1790 cm⁻¹ in wave number in a Raman spectrum of carbon is 400 or more.

### CROSS REFERENCE TO RELATED APPLICATIONS

The present application is a continuation of International application No. PCT/JP2016/064228, filed May 13, 2016, which claims priority to Japanese Patent Application No. 2015-099248, filed May 14, 2015, the entire contents of each of which are incorporated herein by reference.

### FIELD OF THE INVENTION

The present invention relates to a secondary battery, and particularly to a nonaqueous electrolyte secondary battery including: a positive electrode including a positive electrode active material and a positive electrode current collecting foil; a negative electrode including a negative electrode active material and a negative electrode current collecting foil; and a nonaqueous electrolyte.

### BACKGROUND OF THE INVENTION

In recent years, the reduction in size and weight for cellular phones, laptop computers, and the like has been progressed rapidly, and batteries as power sources for driving the phones, the computers, and the like have been required to have higher capacities. Under such circumstances, nonaqueous electrolyte secondary batteries typified by lithium ion secondary batteries are widely used as power sources.

As such a nonaqueous electrolyte secondary battery as described above, for example, Patent Document 1 discloses a nonaqueous electrolyte secondary battery as described below, which has excellent high-rate characteristics, and cycle characteristics at high temperatures.

More specifically, Patent Document 1 discloses a nonaqueous electrolyte secondary battery including: a positive electrode in which a positive electrode active material containing layer including a positive electrode active material containing lithium iron phosphate and a conductive agent is formed on a surface of a positive electrode current collector; a negative electrode including a carbon material; and a nonaqueous electrolyte, wherein as the nonaqueous electrolyte, a nonaqueous electrolyte containing at least one of vinylene carbonate and a derivative thereof is used (See Patent Document 1, Claim 1).

In addition, Patent Document 1 discloses that the packing density of the positive electrode active material containing layer is adjusted to 1.7 g/cm³ or more (see Patent Document 1, Claim 4); the packing density of the positive electrode active material containing layer is adjusted to 3.15 g/cm³ or less (see Patent Document 1, Claim 5); the surface of lithium iron phosphate is coated with carbon, and the amount of carbon with respect to lithium iron phosphate is adjusted to 0.5 to 5 mass% (see Patent Document 1, Claim 6); the median diameter of lithium iron phosphate, measured with a laser diffraction-type particle size distribution measurement system is 3.5 μm or less (see Patent Document 1, Claim 7); and the BET specific surface area of lithium iron phosphate is adjusted to 10 m²/g or more (see Patent Document 1, Claim 8).

Furthermore, Patent Document 1 discloses that the nonaqueous electrolyte containing at least one of vinylene carbonate and a derivative thereof as described above improves the capacity retention rate after 50 cycles in a high-temperature (55° C.) cycle test.

In addition, the vinylene carbonate is assumed to serve as a coating film that covers the negative electrode and the positive electrode, thereby, as a result, making it possible to suppress elation of iron ions from the positive electrode and deposition of iron on the negative electrode,

However, since the coating film formed from the vinylene carbonate grows with each cycle, vinylene carbonate will be continuously consumed within the battery. Therefore, there is a problem that once vinylene carbonate is all consumed, drastic cycle deterioration is caused.

In addition, the coating film made of the vinylene carbonate continues to grow, thereby increasing the thickness of the coating film, and thus causing an increase in resistance, and there is thus a problem that high-rate characteristics are degraded.

Patent Document 1: Japanese Patent Application Laid-Open No. 2007-213961

### SUMMARY OF THE INVENTION

The present invention is intended to solve the problems mentioned above, and an object of the present invention is to provide a nonaqueous electrolyte secondary battery with lithium iron phosphate as a positive electrode active material, which has excellent input/output characteristics, and has favorable cycle characteristics even at high temperature.

In order to solve the above-mentioned problems, a nonaqueous electrolyte secondary battery according to an embodiment of the present invention includes a positive electrode, a negative electrode, and a non-aqueous electrolyte. The positive electrode has a positive electrode active material containing layer on a surface of a positive electrode current collector, and the positive electrode active material containing layer includes a positive electrode active material containing lithium iron phosphate coated with amorphous carbon, and a conductive agent. The negative electrode has a negative electrode active material containing layer on a surface of a negative electrode current collector, and the negative electrode active material containing layer includes a negative electrode active material that occludes and releases lithium. When a coated state of the lithium iron phosphate with the amorphous carbon is quantitatively expressed by Raman spectroscopy, an intensity area, ratio A (C/L) of a diffraction line that appears at 935 cm⁻¹ to 965 cm⁻¹ in wave number in a Raman spectrum of lithium iron phosphate (hereinafter, L) to a diffraction line that appears at 965 cm⁻¹ to 1790 cm⁻¹ in wave number in a Raman spectrum of carbon (hereinafter, C) is 400 or more.

In the nonaqueous electrolyte secondary battery according to an embodiment of the present invention, an amount of the amorphous carbon included in the positive electrode active material is preferably 1.0 to 2.0 weigh %.

When the battery is configured as mentioned above, an adequate electron conduction network is formed in the electrode, thereby making it possible to minimize the lithium diffusion distance within the lithium iron phosphate which is high in resistance, and thus provide a nonaqueous electrolyte secondary battery which has excellent input/output characteristics. In addition, it becomes possible to sufficiently secure the binding force required for electrode formation.

Furthermore, the positive electrode active material preferably has a BET specific surface area of 9.0 m²/g or more.

The battery is configured as mentioned above, thereby making it possible to minimize the lithium diffusion distance within the lithium iron phosphate which is high in resistance, and thus provide a nonaqueous electrolyte secondary battery which has excellent input/output characteristics. Furthermore, the positive electrode active material more preferably has the BET specific surface area of 10 m²/g to 15 m²/g, and in that case, the above-mentioned advantageous effect can be obtained maximally.

In addition, in the nonaqueous electrolyte secondary battery according to an embodiment of the present invention, the positive electrode active material containing layer preferably contains, by ratio, 70 to 94 parts by weight of the positive electrode active material, 5 to 20 parts by weight of powdered carbon to serve as a conductive aid, and 1 to 10parts by weight or less of a binder.

The battery is configured as mentioned above, thereby making it possible to form an adequate electron conduction network in the electrode and sufficiently secure the binding force required for electrode formation.

Furthermore, more preferably, the positive electrode active material is adjusted to 70 to 90 parts by weight, powdered carbon to serve as a conductive aid is 8 to 20 parts by weight, and a binder is 2 to 10 parts by weight, and in that case, the above-mentioned advantageous effect can be obtained, maximally.

In addition, in the nonaqueous electrolyte secondary battery according to the present invention, the lithium iron phosphate included in the positive electrode active material is preferably represented by the following general formula (1):

LiₓFe_{y}P_{z}O₄ (1)

where x, y, z in the formula (1) satisfy the relationships of 0.5<x/y<1.5 and y/z>1, and the Fe site may be partially substituted with at least one selected from the group consisting of Mn, Ni, Mg, Ca, Ti, Cr, Zr, Zn, and Nb, the Li site may be partially substituted with Na, and the P site may be partially substituted with Si.

The use of, as the lithium iron phosphate included in the positive electrode active material, a phosphate represented by the formula (1) described, above, makes it possible to inhibit the production of a high-resistance lithium phosphate compound on the particle surfaces, thereby providing an excellent nonaqueous electrolyte secondary battery.

In addition, the negative electrode active material preferably contains a carbon material as its main constituent.

The use of the negative electrode active material containing a carbon material as its main constituent makes it possible to provide a nonaqueous electrolyte secondary battery which has excellent input/output characteristics.

In accordance with the above features, a nonaqueous electrolyte secondary battery can be provided which has excellent input/output characteristics.

More specifically, when the positive electrode active material in which the intensity area ratio A (C/L) of a diffraction line that appears at 935 cm⁻¹ to 965 cm⁻¹ in wave number in the Raman spectrum of lithium iron phosphate (L) to a diffraction line that appears at 965 cm⁻¹ to 1790 cm⁻¹ in wave number in a Raman spectrum of carbon (C) is 400 or more according to Raman spectroscopy is coated with amorphous carbon, the coverage is high. Therefore, the intensity area ratio A (C/L) which is a carbon coating parameter is set to be 400 or more, thereby making it possible to suppress Fe elution from the lithium iron phosphate, and thus suppressing deterioration of lifetime caused by Fe elution. In addition, satisfying the requirement will extensively cover the surface of lithium iron phosphate which is low in electronic conductivity with amorphous carbon which is conductive, thus making it possible to minimize the lithium diffusion distance within the lithium iron phosphate which is high in resistance, and thus provide a nonaqueous electrolyte secondary battery which has excellent input/output characteristics.

### BRIEF EXPLANATION OF THE DRAWINGS

FIG. 1 is a graph showing the relationship between the “intensity area, ratio A (C/L)” (carbon coating parameter) representing the coated state of lithium iron phosphate constituting a positive electrode with amorphous carbon, and the capacity retention rate for a nonaqueous electrolyte secondary battery (battery element) according to an embodiment (Embodiment 1) of the present invention.

FIG. 2 is a graph showing the relationship between the “intensity area ratio A (C/L)” representing the coated state of lithium iron phosphate constituting the positive electrode with amorphous carbon, and the amount of Fe included in a negative electrode for the nonaqueous electrolyte secondary battery (battery element) according to the embodiment (Embodiment 1) of the present invention.

### DETAILED DESCRIPTION OF THE PREFERRED EMBODIMENTS OF THE INVENTION

Before presenting an embodiment of the present invention, the outline of a configuration according to the present invention will be described first. In the nonaqueous electrolyte secondary battery according to an embodiment of the present invention, a positive electrode active material containing lithium iron phosphate coated with amorphous carbon is used as a negative electrode active material. It is desirable to use, as lithium iron phosphate, a phosphate represented by formula: LiₓFe_{y}P_{z}O₄. In the formula, x, y, z satisfy the relationships of 0.5<x/y<1.5 and y/z>1, and the Fe site may be partially substituted with at least one selected from the group consisting of Mn, Ni, Mg, Ca, Ti, Cr, Zr, Zn, and Nb, the Li site may be partially substituted with Na, and the P site may be partially substituted with Si.

In the nonaqueous electrolyte secondary battery according to the present invention, a carbon material, silicon, tin, germanium, aluminum, lithium, or the like material can be used as a constituent material of the negative electrode active material. The advantageous effect of the present invention can be obtained in the case of using any of the foregoing materials. As the carbon material, graphite, soft carbon, hard carbon, coke, or the like can be used.

In addition, as a nonaqueous solvent for the nonaqueous electrolyte solution, for example, propylene carbonate (PC), ethylene carbonate (EC), butylene carbonate (BC), diethyl carbonate (DEC), dimethyl carbonate (DMC), ethyl methyl carbonate (EMC), Gamma-butyrolactone (GBL), 1,2-dimethoxyethane (DME), methyl acetate (MA), methyl propionate (MP), ethyl acetate (EA), and the like can be used alone, or two or more thereof can be used in mixture.

Vinylene carbonate (VC), vinylethylene carbonate (VEC), or the like may be added to the nonaqueous solvent of the nonaqueous electrolyte solution. It is to be noted that the additive amount of vinylene carbonate (VC), vinylethylene carbonate (VEC), or the like is preferably adjusted such that the proportion of the additive to the nonaqueous electrolyte solution falls within the range of 0.1 to 5 wt %.

In the nonaqueous electrolyte solution, various electrolytes commonly used in nonaqueous electrolyte secondary batteries can be used as an electrolyte to be dissolved in the nonaqueous solvent. For example, LiPF₆, LiBF₄, LiCF₃SO₃, LiN(CF₃SO₂)₂, Li(C₂F₆SO₂)₂, LiN(CF₃SO₂) (C₄F₉SO₂), LiC(C₂F₅SO₂)₃, LiAsF₆, LiClO₄, and the like can be used alone, or two or more thereof can be used in mixture. The amount of the electrolyte preferably falls within the range of 0.5 to 1.5 mol % with respect to the amount of the solvent.

As a separator that electrically insulates the positive electrode and the negative electrode, a microporous membrane composed of one or more selected from polyethylene (PE), polypropylene (PP), polyethylene terephthalate (PET), and the like can be used. The microporous membrane may include therein a filler such as alumina (Al₂O₃), silica (SiO₂), and titania (TiO₂).

As a carbon material for use in the conductive agent included in the positive electrode, for example, massive carbon such as acetylene black, fibrous carbon such as VGCF, and the like can be used alone, or two or more thereof can be used in mixture.

### Embodiment

Features of the present invention will be described in more detail below with reference to an embodiment of the present invention.

(1) Preparation of Positive Electrode

A material containing lithium iron phosphate (hereinafter referred to as L) coated with amorphous carbon was used for the positive electrode active material.

In addition, acetylene black (AB) was used as a conductive agent constituting the positive electrode. In addition, polyvinylidene fluoride (PVdF) was used as a binder constituting the positive electrode.

Then, by ratio:

LiFePO₄ carbon composite (L/C): 80 parts by weight

Acetylene black (AB) as a conductive agent: 15 parts by weight.

Polyvinylidene fluoride (PVdF) as a binder: 5 parts by weight were mixed, and mixed with N-methyl-2-pyrrolidone and cobbled stones of φ2 mm, followed by ball mill grinding, thereby preparing a positive electrode combination slurry.

Next, a positive electrode active material layer was formed by uniformly applying the positive electrode combination slurry mentioned above to both sides of a band-like aluminum foil of 20 μm in thickness, dried, and then subjected to compression molding with a roll press machine, thereby preparing a band-like positive electrode (layer). Further, the density (designed value) of the positive electrode layer was adjusted to 2.0 g/cm³. In addition, the thickness of the positive electrode layer was set to be 25 μm.

For the obtained positive electrode, Raman spectroscopic measurement was performed with a Raman spectrometer (laser wavelength: 532 nm).

Specifically, the intensity area ratio A (C/L) of a diffraction line that appears in the range of 935 cm⁻¹ to 965 cm⁻¹ in wave number in the Raman spectrum of lithium iron phosphate (L) to a diffraction line that appears in the range of 965 cm⁻¹ to 1790 cm⁻¹ in wave number in a Raman spectrum of carbon (hereinafter, C) was calculated, thereby quantitatively evaluating the coated state of the lithium iron phosphate with amorphous carbon. The results are shown in Table 1.

It is to be noted that since the “intensity area ratio A (C/L)” described above represents the coated state of lithium iron phosphate with amorphous carbon, the “intensity area ratio A (C/L)” may be hereinafter referred to as a “carbon coating parameter”.

In addition, Table 1 also shows therein the amount of carbon (mass %) included in each positive electrode active material and the specific surface area (m²/g) of each positive electrode material.

TABLE 1

| | Intensity | | | | | |
|---|---|---|---|---|---|---|
| | Area | | | | Amount | |
| | Ratio A of | | | | of Fe | |
| | Diffraction | | | Capacity | included | |
| | Line | Carbon | Specific | Retention | in | |
| | (Carbon | Amount | Surface | Rate | Negative | |
| | Coating | (weight | Area | (2000 | Electrode | DCR |
| | Parameter) | %) | (m²/g) | cycles) | (mg) | (Ω) |
| Example 1 | 660 | 1.27 | 10.5 | 93.3% | 0.088 | 1.83 |
| Example 2 | 620 | 1.23 | 10.7 | 94.8% | 0.104 | 1.82 |
| Example 3 | 615 | 1.25 | 10.9 | 95.0% | 0.106 | 1.78 |
| Example 4 | 531 | 1.21 | 10.8 | 93.3% | 0.141 | 1.77 |
| Example 5 | 412 | 1.15 | 10.7 | 90.6% | 0.182 | 1.81 |
| Example 6 | 660 | 1.26 | 9.5 | 94.2% | 0.087 | 1.88 |
| Example 7 | 660 | 1.23 | 12.9 | 93.9% | 0.085 | 1.74 |
| Example 8 | 660 | 1.25 | 8.0 | 93.0% | 0.090 | 2.32 |
| Example 9 | 705 | 3.15 | 14.0 | 95.9% | 0.065 | 2.50 |
| Comparative | 308 | 0.92 | 9.6 | 89.2% | 0.201 | 1.93 |
| Example 1 | | | | | | |

(2) Preparation of Negative Electrode

Graphite (natural graphite) (Gr) was prepared as a negative electrode active material, and polyvinylidene fluoride (PVdF) was prepared as a binder.

Then, the graphite (Gr) and polyvinylidene fluoride (PVdF) mentioned above were mixed at a ratio of Gr (parts by weight):PVdF (parts by weight)=95:5, and dispersed in N-methyl-2-pyrrolidone to prepare a negative electrode combination slurry.

Next, a negative electrode active material layer was formed by uniformly applying the negative electrode combination slurry mentioned above to both sides of a band-like copper foil of 20 μm in thickness, dried, and then subjected to compression molding with a roll press machine, thereby preparing a band-like negative electrode (layer).

Further, the density (designed value) of the negative electrode layer was adjusted to 1.3 g/cm³. In addition, in the preparation of the negative electrode layer, the negative electrode combination was applied so that the negative electrode capacity was 180% of the positive electrode capacity. In addition, the thickness of the negative electrode layer was set to be 25 μm.

(3) Preparation of Electrolyte Solution

In a mixed solvent of 25% by volume of ethylene carbonate (EC) and 75% by volume of ethyl methyl carbonate (EMC), 1.0 M LiPF₆ was dissolved, further with the addition of vinylene carbonate (VC) thereto such that the proportion thereof to the entire electrolyte solution was 1.0 weight %, thereby preparing an electrolyte solution.

(4) Preparation of Battery (Battery Element)

According to this embodiment, a stacked battery element was prepared, which was structured such that a plurality of strip positive electrodes and a plurality of strip negative electrodes prepared in the way described above were alternately stacked, with a plurality of strip separators interposed, therebetween.

The dimensions of the positive electrode were adjusted to 50 mm×50 mm, and the dimensions of the negative electrode were adjusted to 52 mm×52 mm.

As the separators, a microporous polypropylene film of 20 μm in thickness was used.

Then, the positive electrodes, negative electrodes, and separators mentioned above were stacked on one another so that the separators were interposed between the positive electrodes and the negative electrodes, thereby preparing a battery element.

Then, current collection leads were ultrasonically welded to the thus prepared battery element, and housed in a bag-like outer package made of aluminum laminate prepared by thermally welding three sides.

Subsequently, 60 g of the electrolyte solution prepared in the way described above was injected into the bag-like outer package, and the aluminum laminate was then sealed, thereby preparing a battery (battery element).

(5) Characterization

(5-1) Charge/Discharge Cycle Test

The battery (battery element) prepared in the way described above was repeatedly charged and discharged under the following charging/discharging conditions, thereby examining high-temperature cycle characteristics of each battery (battery element).

<Charging/Discharging Condition>

(a) Charging Condition

Each battery (battery element) was charged at a

constant current of 1 CA under a temperature condition of 55° C. until the battery voltage reached 3.5 V, and further charged at a constant voltage of 3.5 V until the current attenuated down to 1/50 CA.

(b) Discharging Condition

Each battery (battery element) was discharged at 55° C. at a constant current of 1 CA until the battery voltage reached 2.5 V.

Under the conditions mentioned above, each battery (battery element) was repeatedly charged, and discharged, and the capacity retention rate (discharge capacity retention rate) after 200 cycles, which is an evaluation item, and the amount of Fe included in the negative electrode were measured by the following measurement method.

(c) Capacity Retention Rate

The discharge capacity was measured after repeating 2000 cycles of charge/discharge, and the ratio to the discharge capacity at the start of charge/discharge (capacity retention rate) was obtained.

The results are also shown together in Table 1.

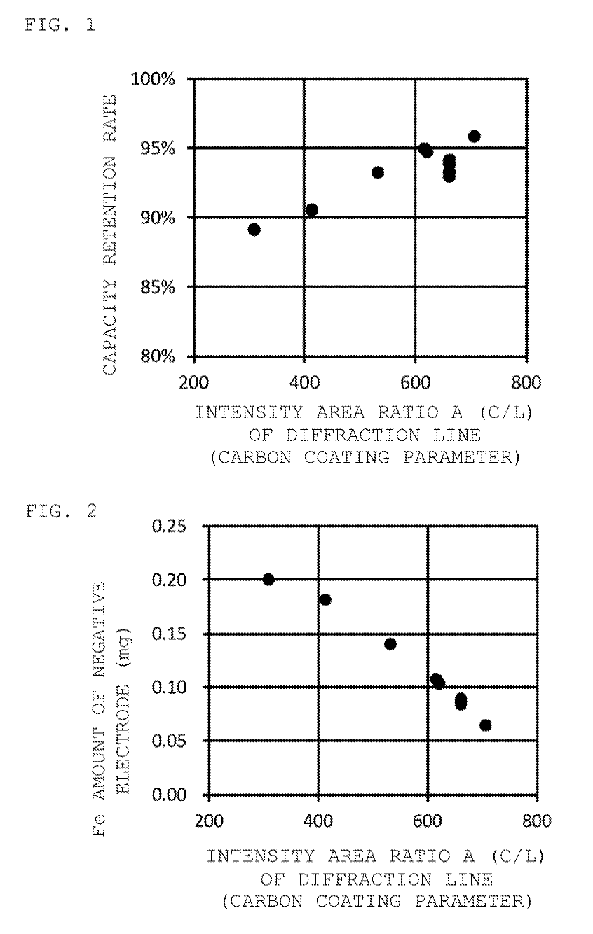

In addition, FIG. 1 shows the relationship between the “intensity area ratio A (C/L)” (carbon coating parameter) representing the coated state of lithium iron phosphate constituting the positive electrode with amorphous carbon, and the capacity retention rate.

(d) Measurement of Amount of Fe included in Negative Electrode

After completing the 2000 cycles of charge/discharge, each battery evaluated for the high-temperature cycle characteristics as mentioned above was disassembled, the negative electrode active material containing layer was peeled off from the negative electrode current collector, and the amount of Fe present on the negative electrode active material containing layer (the amount of Fe included per 1 g of the negative electrode active material containing layer) was measured with the use of ICP emission spectrometry. The results are also shown together in Table 1.

In addition, FIG. 2 shows the relationship between the “intensity area, ratio A (C/L)” (carbon coating parameter) representing the coated state of lithium iron phosphate constituting the positive electrode with amorphous carbon, and the amount of Fe included in the negative electrode.

As shown in Table 1, in the case of Examples 1 to 9, it has been confirmed that the “intensity area ratio A (C/L)” (carbon coating parameter) representing the coated state of lithium iron phosphate constituting the positive electrode with amorphous carbon is 400 or more, thus making the capacity retention rate after the 2000 cycles of charge/discharge as high as 90% or more.

On the other hand, in the case of Comparative Example 1 with the “intensity area ratio A (C/L)” (carbon coating parameter) less than 400, it has been confirmed that the capacity retention rate is less than 90%.

In addition, in the case of Examples 1 to 9 with the “intensity area ratio A (C/L)” (carbon coating parameter) of 400 or more, it has been confirmed that the deposition of Fe on the negative electrode after the 2000 cycles is suppressed, thereby making it possible to suppress deterioration of lifetime caused by Fe elution from the lithium iron phosphate.

On the other hand, in the case of Comparative Example 1 with the “intensity area ratio A (C/L)” (carbon coating parameter) less than 400, it has been confirmed that the amount of Fe included in the negative electrode is larger as compared with Examples 1 to 9, thereby making the lifetime deterioration caused by Fe elution from the lithium iron phosphate more likely to be caused, which is not preferable.

(5-2) Input Characteristic Test

After 3 cycles of measuring the discharge capacity of the battery under the charging/discharging conditions mentioned above, each battery was charged until the state of charge (SOC) reached 50%, and then charged at a constant current of 1 C to 20 C for 10 seconds, and the direct-current resistance (DCR) was calculated from the slope obtained when the ultimate voltage was plotted against the current value.

The results are also shown together in Table 1.

As shown in Table 1, in the case of Examples 1 to 7 of Table 1 where the “positive electrode active material” used has the “intensity area ratio A (C/L)” (carbon coating parameter) of 400 or more, and the specific surface area of 9.0 m²/g or more, it has been confirmed that the DCR is dramatically decreased, thereby providing a battery (lithium ion secondary battery) which has great input-output characteristics.

In addition, in the case of Example 8 where the positive electrode active material has the BET specific surface area of 8.0 m²/g, favorable results have been obtained regarding the capacity retention rate and the amount of iron included in the negative electrode, but there is a tendency for the DC resistance (DCR) to increase. Therefore, it is preferable to make the BET specific surface area of the positive electrode active material larger than 8.0 m²/g, and in order to more reliably lower the direct-current resistance (DCR), it is desirable make the BET specific surface area larger than 9.0 m².

In addition, as shown in Table 1, in the case of Examples 1 to 7 of Table 1 where the “positive electrode active material” used has the “intensity area ratio A (C/L)” (carbon coating parameter) of 400 or more, and the carbon amount of 2.0 wt % or less, it has been confirmed that the DCR is dramatically decreased, thereby providing a battery (lithium ion secondary battery) which has great input-output characteristics.

In addition, in the case of Example 9 with the carbon amount of 3.15 wt %, favorable results have been obtained regarding the capacity retention rate and the amount of iron included, in the negative electrode, but there is a tendency for the DC resistance (DCR) to increase. Therefore, it is preferable to make the carbon amount smaller than 3.15 wt %, and in order to more reliably lower the direct-current resistance (DCR), it is desirable make the carbon amount smaller than 2.0 wt %.

As can be seen from the embodiment described above, the use of the positive electrode active material with an intensity area ratio A (C/L) of 400 or more, which is high in coverage with amorphous carbon, makes it possible to suppress Fe elution from the lithium iron phosphate, thereby suppressing deterioration of lifetime caused by Fe elution. In addition, covering the lithium iron phosphate surface which is low in electron conductivity with the amorphous carbon which is conductive makes it possible to minimize the lithium diffusion distance within the lithium iron phosphate which is high in resistance, thereby providing a nonaqueous electrolyte secondary battery which has excellent input/output characteristics.

It is to be noted that the present invention is not to be considered, limited, to the embodiment described, above, but various applications and modifications can be made within the scope of the invention, in regard to the constituent material of the negative electrode and the method for forming the negative electrode, the material constituting the separator, the configuration of the separator, and the like.

1. A nonaqueous electrolyte secondary battery comprising:
a positive electrode having a positive electrode active material containing layer on a surface of a positive electrode current collector, the positive electrode active material containing layer comprising:
a positive electrode active material comprising lithium iron phosphate coated with amorphous carbon; and
a conductive agent;
a negative electrode having a negative electrode active material containing layer on a surface of a negative electrode current collector, the negative electrode active material containing layer comprising a negative electrode active material which occludes and releases lithium; and
a nonaqueous electrolyte,
wherein, when a coated state of the lithium iron phosphate coated with the amorphous carbon is quantitatively expressed by Raman spectroscopy, an intensity area ratio A (C/L) of a diffraction line L that appears at 935 cm⁻¹ to 965 cm⁻¹ in wave number in a Raman spectrum of lithium iron phosphate to a diffraction line C that appears at 965 cm⁻¹ to 1790 cm⁻¹ in wave number in a Raman spectrum of carbon is 400 or more.

2. The nonaqueous electrolyte secondary battery according to claim 1, wherein an amount of the amorphous carbon included in the positive electrode active material is 0.1 wt % to 5 wt %.

3. The nonaqueous electrolyte secondary battery according to claim 1, wherein the positive electrode active material has a BET specific surface area of 9.0 m²/g or more.

4. The nonaqueous electrolyte secondary battery according to claim 3, wherein the BET specific surface area is 10 m²/g to 15 m²/g.

5. The nonaqueous electrolyte secondary battery according to claim 1, wherein the positive electrode active material containing layer contains, by ratio, 70 to 94 parts by weight of the positive electrode active material, 5 to 20 parts by weight of powdered carbon, and 1 to 10 parts by weight of a binder.

6. The nonaqueous electrolyte secondary battery according to claim 5, wherein the positive electrode active material is 70 to 90 parts by weight, the powdered carbon is 8 to 20 parts by weight, and the binder is 2 to 10 parts by weight.

7. The nonaqueous electrolyte secondary battery according to claim 1, wherein
the lithium iron phosphate included in the positive electrode active material is:
LiₓFe_{y}PₓO₄
wherein 0.5<x/y<1.5 and y/z>1.

8. The nonaqueous electrolyte secondary battery according to claim 7, wherein the Fe site is partially substituted with at least one selected from the group consisting of Mn, Ni, Mg, Ca, Ti, Cr, Zr, Zn, and Nb.

9. The nonaqueous electrolyte secondary battery according to claim 8, wherein the Li site is partially substituted with Na.

10. The nonaqueous electrolyte secondary battery according to claim 9, wherein the P site is partially substituted with Si.

11. The nonaqueous electrolyte secondary battery according to claim 7, wherein the Li site is partially substituted with Na.

12. The nonaqueous electrolyte secondary battery according to claim 11, wherein the P site is partially substituted with Si.

13. The nonaqueous electrolyte secondary battery according to claim 7, wherein the P site is partially substituted with Si.

14. The nonaqueous electrolyte secondary battery according to claim 7, wherein an amount of the amorphous carbon included in the positive electrode active material is 0.1 wt % to 5 wt %.

15. The nonaqueous electrolyte secondary battery according to claim 7, wherein the positive electrode active material has a BET specific surface area of 9.0 m²/g or more.

16. The nonaqueous electrolyte secondary battery according to claim 15, wherein the BET specific surface area is 10 m²/g to 15 m²/g.

17. The nonaqueous electrolyte secondary battery according to claim 7, wherein the positive electrode active material containing layer contains, by ratio, 70 to 94 parts by weight of the positive electrode active material, 5 to 20 parts by weight of powdered carbon, and 1 to 10 parts by weight of a binder.

18. The nonaqueous electrolyte secondary battery according to claim 17, wherein the positive electrode active material is 70 to 90 parts by weight, the powdered carbon is 8 to 20 parts by weight, and the binder is 2 to 10 parts by weight.

19. The nonaqueous electrolyte secondary battery according to claim 1, wherein the negative electrode active material contains a carbon material as a main constituent thereof.
